(19) United States
(12) Patent Application Publication
(10) Pub. No.: US 2007/0059421 A1
(43) Pub. Date: Mar. 15, 2007

(54) Methods and compositions to improve the palatability of foods

(76) Inventors: Steven J. Catani, Athens, GA (US); Steven D. Clarke, North Brunswick, NJ (US); Shyhyuan Liao, West Windsor, NJ (US); Melanie Loades, Surrey (GB); Ian R. Miller, Chicago, IL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/225,737

(22) Filed: Sep. 13, 2005

(51) Int. Cl. A23L 1/236

(52) U.S. Cl. 426/548

(57) ABSTRACT

A sweetener composition containing a non-bitter sweetener and a bitter suppressing agent is provided. Methods of producing these sweetener compositions and foodstuffs and kits containing the same are also provided.

### FIELD OF THE INVENTION

The present invention relates to a sweetener composition that includes a non-bitter sweetener and a bitter suppressing agent. Methods of making such a sweetener composition and foodstuffs containing the same are also provided. Kits containing the sweetener compositions are also described.

### BACKGROUND OF THE INVENTION

People often customize the taste of food and beverages by adding sweeteners thereto. For example, sweeteners are added to beverages, such as, coffee and tea; on cereals; on fruit; as toppings on baked goods, and in many other ways. Sweetening a food or beverage alters its flavor and usually increases its appeal. This behavior is found in all cultures, but is especially prevalent in western cultures.

The most common sweeteners are nutritive sweeteners. Nutritive sweeteners not only provide sweetness, but are also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in wide spread use, is produced from many sources, e.g., sugar cane and sugar beet roots.

Sugar alcohols are another form of sweetener. Sugar alcohols are chemically alcohols, but are derived from sugar molecules. Sugar alcohols vary in sweetness from about half as sweet to about as sweet as sucrose. Accordingly, sugar alcohols may be used in place of sugar. Sugar alcohols have about one-half to three-quarters the amount of calories of sugar on a per weight basis. Sugar alcohols are slowly and incompletely absorbed from the small intestine into the blood. Absorbed sugar alcohols are converted to energy by processes that require little or no insulin. Accordingly, these sweeteners may be used by diabetics or those on low-carbohydrate diets.

High intensity sweeteners are well known alternatives to nutritive sweeteners. High intensity sweeteners provide sweetness without the calories and other metabolic impacts of the nutritive sweeteners. In many cases, high intensity sweeteners provide a sweet flavor that is preferred to nutritive sweeteners. Some high intensity sweeteners, such as, aspartame, are nutritive, but are so intense that they still provide negligible calories because very small amounts are required. Other high intensity sweeteners, such as, for example sucralose, are not absorbed when ingested and are, therefore, non-nutritive sweeteners.

Tabletop sweeteners are generally used to improve the enjoyment of the foods and beverages with which they are used. Many types of sweeteners are available for consumers to customize the sweetness of the foods and beverages they consume to suit their taste.

The commonly available sweeteners have slightly different tastes that are variably preferred by individuals. Many sweeteners impart a bitter taste to the foods they sweeten. Saccharin, for example, is a sweetener that is known to impart a bitter taste. Other sweeteners have other taste components such as lingering metallic tastes, cooling or drying sensations, or combinations of the above sensations.

Often the makers or users of these sweeteners add other components to them to overcome a less pleasant taste, for example, a bitter taste. For example, cream of tartar may be added to saccharin to offset its bitterness; and 2,4-dihydroxybenzoic acid may be added to sucralose to control lingering sweetness.

Bitter flavors also occur in other foods and ingestibles. For example, some coffees and teas as well as many pharmaceuticals are known to be bitter. Many compounds have been discovered that are useful to overcome bitterness. In recent years, several compounds have been identified that attenuate (or amplify) certain taste receptors including those responsible for sensing a bitter taste. Compounds that work by these mechanisms are effective bitterness suppressors (or amplifiers).

Consumers have variable preference for bitterness and many foods have bitter tastes that are essential to their character. Coffee is an example of a food with an essential bitterness character, but other examples are well known. Consumers often use sweeteners to overcome such bitter tastes. One of the most common uses of table sugar (sucrose) is to sweeten coffees and teas, in both cases eliminating some of the bitter notes. The same is true with pharmaceutical preparations, which often contain sweeteners to mask bitter taste. The old adage, “a spoonful of sugar helps the medicine go down” is largely reflective of sugar's ability to overpower less desirable tastes.

While sucrose may overcome some bitter tastes, it is not perfect and consumers often add other components to foods to further overcome the bitter flavors. For example, chicory is sometimes added to coffee to overcome the bitter flavors. Thus, supplementing a foodstuff with only a non-bitter sweetener is often not sufficient to meet consumer preference.

It would, therefore, be advantageous to provide a sweetener composition that incorporates the best of all previous products and improves upon them. Such a composition would improve the full taste, functionality, and physical properties of traditional sucrose. In particular, it would be advantageous to provide a composition with a non-bitter sweetener and a bitter suppressing agent. These and other objects of the present invention are described in greater detail below.

### SUMMARY OF THE INVENTION

One embodiment of the present invention is a sweetener composition comprising, consisting of, and/or consisting essentially of a bitter suppressing agent and a non-bitter sweetener.

Another embodiment of the invention is a method of reducing the bitter taste of a foodstuff. This method comprises, consists of, and/or consists essentially of contacting the foodstuff with a bitter taste-reducing quantity of a composition comprising a bitter suppressing agent and a non-bitter sweetener.

A further embodiment of the invention is a method of making a sweetener composition. This method comprises, consists of, and/or consists essentially of combining a bitter suppressing agent with a non-bitter sweetener.

A further embodiment of the invention is a sweetening kit, which comprises consists of, and/or consists essentially of in packaged combination, a first container comprising a bitter suppressing agent and a non-bitter sweetener, a second container comprising, consisting of, and/or consisting essentially of an unsweetened beverage mix, and instructions for sweetening the unsweetened beverage mix.

A further embodiment of the invention is a foodstuff that contains a composition that comprises, consists of, and/or consists essentially of a bitter suppressing agent and a non-bitter sweetener.

### DETAILED DESCRIPTION OF THE INVENTION

The present invention is directed to the production of a sweetener composition containing a non-bitter sweetener and a bitter suppressing agent. It has been found that when a bitter suppressing agent is used in combination with a non-bitter sweetener to sweeten a foodstuff, e.g., a food or beverage, consumers will prefer the combination over the non-bitter sweetener alone. This is unexpectedly and surprisingly true when the sweetener does not itself have an overt bitter note or taste.

While it is known to add a bitter suppressing agent to saccharin, which has an overt bitter note or imparts a bitter note to foods with which it is used, it is not known to add a bitter suppressing agent to a non-bitter sweetener, such as, for example, sucralose, which does not have an overt bitter note and does not contribute to the bitterness of a foodstuff to which it is added. Indeed, it has unexpectedly been found that the addition of a bitter suppressing agent to a non-bitter sweetener creates a preference by consumers for such a composition when used in various applications.

Another surprising feature of the present invention is the double benefit of having a sweetener that overcomes bitterness on its own, without adding any inherent bitterness, and a bitter suppressing agent. In other words, if a bitter suppressing agent is mixed with a sweetener that is bitter (e.g., saccharin), some of the effect of the bitter suppressing agent may be used to overcome or mask the inherent bitterness of the sweetener as opposed to when a bitter suppressing agent is used with a non-bitter sweetener.

Accordingly, one embodiment of the present invention is a sweetener composition, which includes a bitter suppressing agent and a non-bitter sweetener.

As used herein, unless otherwise indicated, the term “non-bitter sweetener” means any food-grade sweetener that exhibits little or no bitter taste. Non-bitter sweeteners include both intense and non-intense, and both nutritive and non-nutritive sweeteners. Non-limiting examples of non-bitter sweeteners useful in the present invention include sucralose, sucrose, fructose, glucose, tagatose, sugar alcohols, trehelose, and combinations thereof. Preferably the non-bitter sweetener is sucralose or sucrose.

As used herein, unless otherwise indicated, the term “sugar alcohol” means a food-grade alcohol derived from a sugar molecule. Sugar alcohols useful in the present invention include, for example, mannitol, sorbitol, lactitol, isomalt, erythritol, xylitol, maltitol, hydrogenated isomaltulose, hydrogenated starch hydrolyzates, and combinations thereof.

As used herein, unless otherwise indicated, the term “food-grade material” for purposes of the present invention is a material that is safe for use in a food or beverage that will be consumed by a human (or animal). Standards for determining whether materials are safe for human consumption are set forth in the Codex Alimentarius produced by the World Health Organization (1999), which is incorporated by reference herein as if recited in full.

As used herein, unless otherwise indicated, the term “bitter suppressing agent” means any food-grade material that masks or blocks the taste of bitter substances and may be used to enhance the flavor of a beverage or a food product including a sweetening composition and to block and/or mask the bitter taste of substances in a high intensity sweetener (such as the metal ions, e.g., potassium ion, from acesulfame K). Any food-grade material that blocks and/or masks the bitter taste of substances (such as, metal ions) in a sweetener without destroying the taste quality of a foodstuff, e.g., a beverage or a food product including the sweetening composition may be suitable for use as a bitter suppressing agent in the present invention.

Non-limiting examples of a bitter suppressing agent according to the present invention include adenosine 5′ monophosphate, thymidine 5′ monophosphate, adenosine 5′ diphosphate, adenosine 3′ monophosphate, adenosine 5′-succinate, adenosine 5′ triphosphate, adenosine 2′ monophosphate, 5′-cytidylic acid, inosinic acid, maltol, aliphatic polyols, monellin, thaumatin, ribonucleosides, ribonucleotides, deoxy analogues of ribonucleosides and ribonucleotides, D-galactose, phospholipids, cinnamic acid, derivatives, salts, and combinations thereof. Other examples of a bitter suppressing agent according to the present invention also include a mixture of natural flavors sold under the trademark “K-BLOCK” or “K-BLOCK II” (by Natura, Inc., Lansing, Mich., USA) and Firmenich flavoring product no. 501.482/TP 04.24 (Plainsboro, N.J.). Preferred bitter suppressing agents are flavorings or components with functional groups, e.g., hydrophilic groups, that mask the target receptor site(s) for bitter taste.

Non-limiting examples of phospholipid derivatives include phosphatidylcholine, phosphatidylethanolamine, phosphatidylinositol (PI), phosphatidic acid (PA), and combinations thereof. Non-limiting examples of cinnamic acid derivatives include paramethoxycinnamaldehyde, coumaric acid, caffeic acid, ferulic acid, sinapic, and combinations thereof.

As used herein, unless otherwise indicated, the term “high intensity sweetener” means a food-grade material that provides a high sweetness per unit mass as compared to a nutritive sweetener and provides little or no nutritive value. Among the high intensity sweeteners, sucralose is known to not have a bitter aftertaste, to have a sugar-like, sweet taste, and to impart no calories to foodstuffs to which it is added. On its own, sucralose suppresses bitterness; but, when combined with a bitter suppressing agent, there is a surprisingly improved preference for foodstuffs to which such a composition is added.

As used herein, unless otherwise indicated, the term “foodstuff” means any edible material to which a composition of the present invention may be added. Foodstuffs useful in the present invention include, for example, food, such as, cake and cookie mixes and beverages or beverage mixes. Non-limiting examples of beverages useful in the present invention include coffee, tea, milk, seltzer, unsweetened drink mixes, and the like.

The intensity of a sweetener may be assessed by determining the amount of the sweetener required to provide sweetness comparable to a predetermined mass of a nutritive sugar, e.g., sucrose. In the present invention, this parameter is expressed in terms of “sucrose equivalent sweetness” (SES). For example, if a sweetener is twice as intense as sucrose, 0.5 g of the sweetener would equal one gram of sucrose equivalent sweetness. Thus, the amount of a sweetener according to the present invention, e.g., a high intensity sweetener disposed in a packet, may provide the sweetness equivalent of a cup of sucrose, or any other unit amount. The sweetener may also be matched to a specific application, such as, for example, a particular cookie or cake mix, cookie dough, beverage or beverage mix.

In the present invention, the weight percentages of the non-bitter sweetener and the bitter suppressing agent may be varied depending on the shelf life, mouth-feel, flavors, and time-intensity profile desired in a foodstuff, e.g., a beverage or other oral product including the sweetening composition. The weight percentages (based on the total weight of the composition) of the non-bitter sweetener in the sweetening composition may be from about 0.01%, such as 0.25%, to about 99.95%, depending on the SES of the sweetener used in the composition.

In the present invention, the composition may contain from about 0.1% to about 80.0% by weight of a non-bitter, high intensity sweetener, preferably, sucralose, based on the total weight of the composition. More preferably, the composition contains from about 0.1% to about 5%, such as for example, from about 0.5% to about 2.5,%, 0.5% to about 1.5%, or about 0.8% to about 1.2% by weight of non-bitter, high intensity sweetener based on the total weight of the composition.

The weight percentages (based on the total weight of the composition) of the bitter suppressing agent may be from about 0.00005% (5 ppm) to about 35%, preferably from about 0.001% to about 35%, such as for example, from about 0.01% to about 2.0%, or from about 0.05% to about 2.0%. Another preferred range for the bitter suppressing agent is from about 0.0001% to about 2% by weight, based on the total weight of the composition.

As used herein, all numerical ranges provided are intended to expressly include at least all numbers that fall between the endpoints of ranges.

The compositions of the present invention may contain one or more food-grade additives. Food-grade additives useful in the present invention include, for example, flavors, texture enhancers, coloring agents (e.g., dyes), bulking agents, and combinations thereof.

As used herein, unless otherwise indicated, the term “flavor” means any food-grade material that may be added to the present compositions to provide a desired flavor to a foodstuff. Flavors useful in the present invention include, for example, cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, derivatives, and combinations thereof.

As used herein, unless otherwise indicated, the term “texture enhancer” means any food-grade material that may be added to the present compositions to provide a desired texture to a foodstuff. Texture enhancers useful in the present invention include, for example, guar gum, alginate, taro gum, gellan gum, xanthium gum, amalose, amalopectin, konjac, salts, derivatives, and combinations thereof.

As used herein, unless otherwise indicated, the term “coloring agent” (e.g., dye) means any substance that may be employed to produce a desired color, for example, in a foodstuff. Such coloring agents are approved for human consumption pursuant an appropriate governmental agency and/or act, such as the Food and Drug Administration (FDA)/Federal Food Drug and Cosmetic Act (FD&C) in the US or an analogous agency of the European Union. For example, the coloring agent may be a food-grade dye or a lake. In the present invention, a “dye” is a water soluble compound, which is available as a powder, granule, liquid or other special purpose form. Dyes are typically used in beverages, dry mixes, baked goods, confections, dairy products, pet foods, and a variety of other products. A “lake” is a water insoluble form of a dye. Typically, lakes are more stable than dyes and are ideal for coloring products containing fats and oils or items lacking sufficient moisture to dissolve dyes. Lakes are typically used in coated tablets, cake and donut mixes, hard candies, and chewing gums.

Coloring agents useful in the present invention include, for example, FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), annatto extract, anthocyanis, aronia/redfruit, beet juice, beet powder, beta-carotene, beta-apo-8-carotenal, black currant, burnt sugar, canthaxanthin, caramel, carbo medicinalis, carmine, carmine/beta-carotene, carmine blue, carminic acid, carrot, carrot oils, chlorophyll, chlorophyllin, cochineal extract, copper-chlorophyll, copper-chlorophyllin, curcumin, curcumin/Cu-chlorophyllin, elderberry, grape, grape skin extracts, hibiscus, lutein, mixed carotenoids, paprika, paprika extract, paprika oleoresin, riboflavin, saffron, spinach, stinging nettle, titanium dioxide, turmeric, and combinations thereof. Preferred coloring agents according to the present invention are FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), and combinations thereof.

As used herein, unless otherwise indicated, the term “bulking agent” means any food-grade material that may be added to the present compositions to increase the bulk of the composition without significantly increasing the calories contained in or the sweetness delivered by the composition. For example, bulking agents may be used to increase the volume of a composition of the present invention (e.g., when the sweetener is a high intensity sweetener) for convenience in, e.g., accurately measuring and dispensing such compositions. Bulking agents useful in the present invention include, for example, maltodextrin, FOS, polydextrose, inulin, fibersol, high amylase carbohydrates, resistant starches, and combinations thereof. A preferred bulking agent useful in the present invention is maltodextrin.

In the present invention, the food-grade additives may comprise up to about 99.9% by weight, based on the total weight of the composition. Preferably, the additives comprise from about 50% to about 99% by weight, based on the total weight of the composition.

Adding a bitter suppressing agent to non-bitter sweeteners not only improves taste for the consumer, but also provides a convenient method for consumers to overcome the undesirable bitter taste associated with many products, e.g., foodstuffs or other oral products. The sweetener compositions of the present invention may be delivered in unit packages, in bulk form, as a liquid, a tablet, a powder, granules, cubes, or any other way sweeteners are delivered.

Generally, the sweetener composition of the present invention may be packaged for industrial or commercial use, such as in the food services industry, or for use by consumers in the same manner as other sweeteners (e.g., a unit dose quantity). A unit dose quantity for the compositions of the present invention may include, for example, a teaspoon, a quart, a cup, a pint, a liter, an ounce, a pound, a gram, 100 grams, a kilogram, or any multiple or fraction thereof, of sucrose equivalent sweetness. These packaged forms may include, for example, boxes, bags, drums, tubs, pouches, containers, jars, and the like, and individual use (i.e., unit package) forms, such as packets or mixtures thereof (e.g., tub containing individual packets). These packaged forms may further include, for example, a container, which is further packaged in a multi-container package or a container that is over-wrapped with a secondary packing material. The compositions of the present invention may be sold to consumers individually, or as a part of a multi-container unit.

As noted above, in the present invention, the compositions may be provided in a package form. Tearing the package, or removing a cap or lid from the package, as appropriate, opens the package. The package may be composed of a coated paper, folded and sealed to create a small pouch. The coating on the paper protects the material in the package from environmental conditions that may affect the product's stability and quality such as odors, moisture, oxygen, and atmospheric contaminants. Coatings that are appropriate for the compositions of the present invention are well known in the art.

The sweetener compositions of the present invention may be incorporated into a foodstuff in the same manner as sugar. Non-limiting examples of foodstuffs that may be used in the present invention include beverages, beverage mixes, cookie or cake mixes, and cookie dough.

In another embodiment, the present invention provides a method of reducing the bitter taste of a foodstuff. This method includes contacting the foodstuff with a bitter taste-reducing quantity of a composition that includes the bitter suppressing agent(s) and non-bitter sweetener(s) of the present invention. Optionally, one or more additives may be combined or incorporated into the composition. In this method, the identity and quantity of the bitter suppressing agent(s), non-bitter sweetener(s), and optional additive(s) are as defined above.

As used herein, unless otherwise indicated, the term a “bitter taste-reducing quantity” means that quantity of a composition of the present invention suitable to noticeably effect the taste of a foodstuff for a consumer. Generally, such a quantity will be about one to two teaspoons of the composition for individual use, but may be more or less depending on intended use.

In this method, the contacting step may be any conventional method for combining ingredients, such as, for example, dry mixing, spray drying, agglomeration, panning, co-crystallization, tabletting, and the like.

Another embodiment of the present invention is a method of making a sweetener composition. This method includes combining a bitter suppressing agent with a non-bitter sweetener. Optionally, one or more additives may be combined or incorporated into the composition. In this method, the identity and quantity of the bitter suppressing agent(s), non-bitter sweetener(s), and optional additive(s) are as defined above.

Another embodiment of the present invention is a sweetening kit. This kit includes, in packaged combination, a first container having a composition that includes a bitter suppressing agent and a non-bitter sweetener, a second container having an unsweetened beverage mix, and instructions for sweetening the unsweetened beverage mix. Optionally, the composition also contains one or more additives.

The identity and quantity of the bitter suppressing agent(s), non-bitter sweetener(s), and optional additive(s) are as defined above. Preferably, the non-bitter sweetener is selected from sucralose, sucrose, fructose, glucose, tagatose, sugar alcohols, trehelose, and combinations thereof. Preferably, the sugar alcohols are selected from mannitol, sorbitol, lactitol, isomalt, erythritol, xylitol, maltitol, hydrogenated isomaltulose, hydrogenated starch hydrolyzates, and combinations thereof. More preferably, the non-bitter sweetener is sucralose or sucrose.

The instructions may be included as a separate insert or printed on the outside of the first and/or second container. The first and second container are selected based on the intended end use and may be the same or different. Examples of containers suitable for use in the present invention include sealable pouches, boxes, bags, packets, and other similar conventional packing materials. The first and second containers are preferably disposed within a larger package sufficient to house both of them and the instructions. Selection of the appropriate package is within the skill of the art.

Another embodiment of the invention is a foodstuff that includes a composition according to the present invention. As noted above, non-limiting examples of foodstuffs include cake and cookie mixes, coffee, tea, unsweetened drink mixes, and the like.

The following examples are provided to further illustrate the compositions and methods of the present invention. These examples are illustrative only and are not intended to limit the scope of the invention in any way.

### EXAMPLES

### Example 1

### Comparative Test: Sweetener and Bitter Suppressing Agent

An experiment is carried out to determine whether the functionality of a known bitter suppressing agent is compromised when added to a beverage in combination with a non-bitter sweetener system. In this experiment, a consumer panel of four to six participants evaluates various beverages. The experiment is carried out with two control drinks (i.e., strong iced tea and strong hot coffee). And, two combination test mixtures are added to 100 ml of both control drinks:
1. 0.5 g SPLENDA® No Calorie Sweetener and 0.2 g Bitter Suppressing Agent (Firmenich flavorings product no. 501.482/TP 04.24)
2. 5 g Sucrose and 0.2 g Bitter Suppressing Agent (Firmenich 501.482/TP 04.24).

The hot coffee is made from 5 g of instant coffee from Kenco Really Rich brand coffee in 100 ml of boiling water. 5 g of coffee solids are weighed out and placed in a 200 ml beaker. Add boiling water and stir well.

The strong iced tea is made from 3 tea bags of PG Tips brand tea in 1 liter of boiling water. Place the three tea bags in a 1.5 liter beaker and then pour 1 liter of boiling water and allow to stand for 3 minutes. After 3 minutes, remove the tea bags and chill the liquid rapidly.

In total, the panelists have 10 samples to assess:
1. Iced Tea Control
2. Iced Tea with SPLENDA® No Calorie Sweetener
3. Iced Tea with Sucrose
4. Iced Tea with SPLENDA® No Calorie Sweetener+Bitter Suppressing Agent
5. Iced Tea with Sucrose+Bitter Suppressing Agent
6. Hot Coffee Control
7. Hot Coffee with SPLENDA® No Calorie Sweetener
8. Hot Coffee with Sucrose
9. Hot Coffee with SPLENDA® No Calorie Sweetener+Bitter Suppressing Agent
10. Hot Coffee with Sucrose+Bitter Suppressing Agent

Panelists are asked to rate the bitterness of the test beverages, control beverages (strong hot coffee and strong iced tea), and control beverages where only a sweetener has been added (0.5 g SPLENDA® No Calorie Sweetener or 5 g sucrose). Panelists are asked to taste each sample and using a scale from 1 to 5 anchored at either end by “Not at all Bitter” (1) and “Extremely Bitter” (5) record how bitter they perceived each sample to be.

The results from the test are clear. The use of the bitter suppressing agent in conjunction with the sweetener has an additive effect—participants perceive both of the test drinks as less bitter when both components are present than when just the sweetener system alone is present. The tables below show the mean bitterness ratings for each of the ten test samples.

TABLE 1
Ice Tea Control

| | | Iced Tea and | | | |
|---|---|---|---|---|---|
| | | SPLENDA ® No | | | Iced Tea and |
| | Iced Tea and | Calorie Sweetener | | | Sucrose and |
| Iced Tea | SPLENDA ® No | and Bitter | Iced Tea | Iced Tea | Bitter |
| Control | Calorie Sweetener | Suppressing Agent | Control | and Sucrose | Suppressing Agent |
| 4.2 | 2.8 | 2 | 4.2 | 2.5 | 1.7 |

TABLE 2
Hot Coffee

| | | Hot Coffee + | | | |
|---|---|---|---|---|---|
| | | SPLENDA ® No | | | |
| | Hot Coffee + | Calorie Sweetener + | | | Hot Coffee + |
| Hot Coffee | SPLENDA ® No | Bitter Suppressing | Hot Coffee | Hot Coffee + | Sucrose + Bitter |
| Control | Calorie Sweetener | Agent | Control | Sucrose | Suppressing Agent |
| 5 | 4 | 3.1 | 5 | 3.6 | 2.5 |

As the data from Tables 1 and 2 show, the test combination mixture of iced tea and SPLENDA® No Calorie Sweetener and bitter suppressing agent is rated 0.8 points less bitter than the iced tea and SPLENDA® No Calorie Sweetener alone. The test combination mixture of hot coffee and SPLENDA® No Calorie Sweetener a and bitter suppressing agent is rated 0.9 points less bitter than the hot coffee and SPLENDA® No Calorie Sweetener alone. These results clearly indicate that the use of a non-bitter sweetener in combination with a bitter suppressing agent does not affect the functionality of the bitterness suppressing agent. Further, the results of the consumer test also indicate that consumers rate the drinks containing the combination mixtures as less bitter than the drinks containing the sweetener alone.

The scope of the present invention is not limited by the description, examples and suggested uses herein and modifications can be made without departing from the spirit of the invention. Thus, it is intended that the present invention cover modifications and variations of this invention provided that they come within the scope of the appended claims and their equivalents.

What is claimed is:

1. A sweetener composition comprising a bitter suppressing agent and a non-bitter sweetener.

2. A sweetener composition according to claim 1, wherein the non-bitter sweetener is selected from the group consisting of sucralose, sucrose, fructose, glucose, tagatose, sugar alcohols, trehelose, and combinations thereof.

3. A sweetener composition according to claim 2, wherein the sugar alcohol is selected from the group consisting of mannitol, sorbitol, lactitol, isomalt, erythritol, xylitol, maltitol, hydrogenated isomaltulose, hydrogenated starch hydrolyzates, and combinations thereof.

4. A sweetener composition according to claim 2, wherein the non-bitter sweetener is sucralose.

5. A sweetener composition according to claim 2, wherein the non-bitter sweetener is sucrose.

6. A sweetener composition according to claim 1, wherein the bitter suppressing agent is selected from the group consisting of adenosine 5′ monophosphate, thymidine 5′ monophosphate, adenosine 5′ diphosphate, adenosine 3′ monophosphate, adenosine 5′-succinate, adenosine 5′ triphosphate, adenosine 2′ monophosphate, 5′-cytidylic acid, inosinic acid, maltol, aliphatic polyols, monellin, thaumatin, ribonucleosides, ribonucleotides, deoxy analogues of ribonucleosides and ribonucleotides, D-galactose, phospholipids, cinnamic acid, derivatives, salts, and combinations thereof.

7. A sweetener composition according to claim 6, wherein the phospholipid derivatives are selected from the group consisting of phosphatidylcholine, phosphatidylethanolamine, phosphatidylinositol, phosphatidic acid, and combinations thereof.

8. A sweetener composition according to claim 6, wherein the cinnamic acid derivatives are selected from the group consisting of paramethoxycinnamaldehyde, coumaric acid, caffeic acid, ferulic acid, sinapic, and combinations thereof.

9. A sweetener composition according to claim 1, wherein the bitter suppressing agent comprises a functional group that masks a receptor for bitterness.

10. A sweetener composition according to claim 1, wherein the non-bitter sweetener is present in an amount from about 0.01% to about 99.95% by weight based on the total weight of the composition.

11. A sweetener composition according to claim 10, wherein the non-bitter sweetener is present in an amount from about 0.1% to about 80% by weight based on the total weight of the composition.

12. A sweetener composition according to claim 11, wherein the non-bitter sweetener is present in an amount from about 0.5% to about 2.5% by weight based on the total weight of the composition.

13. A sweetener composition according to claim 11, wherein the non-bitter sweetener is present in an amount from about 0.1% to about 5% by weight based on the total weight of the composition.

14. A sweetener composition according to claim 13, wherein the non-bitter sweetener is present in an amount from about 0.5% to about 1.5% by weight based on the total weight of the composition.

15. A sweetener composition according to claim 14, wherein the non-bitter sweetener is present in an amount from about 0.8% to about 1.2% by weight based on the total weight of the composition.

16. A sweetener composition according to claim 1, wherein the bitter suppressing agent is present in amount from about 0.00005% to about 35% by weight based on the total weight of the composition.

17. A sweetener composition according to claim 16, wherein the bitter suppressing agent is present in amount from about 0.001% to about 35% by weight based on the total weight of the composition.

18. A sweetener composition according to claim 16, wherein the bitter suppressing agent is present in amount from about 0.0001% to about 2.0% by weight based on the total weight of the composition.

19. A sweetener composition according to claim 16, wherein the bitter suppressing agent is present in amount from about 0.01% to about 2.0% by weight based on the total weight of the composition.

20. A sweetener composition according to claim 19, wherein the bitter suppressing agent is present in amount from about 0.05% to about 1.0% by weight based on the total weight of the composition.

21. A sweetener composition according to claim 1 further comprising one or more food-grade additives.

22. A sweetener composition according to claim 21, wherein the food-grade additives are selected from the group consisting of a flavor, a texture enhancer, a coloring agent, a bulking agent, and combinations thereof.

23. A sweetener composition according to claim 22, wherein the bulking agent is selected from the group consisting of maltodextrin, fructo-ogliosaccharide, polydextrose, inulin, fibersol, high amylase carbohydrates, resistant starches, and combinations thereof.

24. A sweetener composition according to claim 23, wherein the bulking agent is maltodextrin.

25. A sweetener composition according to claim 1, wherein the composition is provided in a unit dose quantity.

26. A sweetener composition according to claim 25, wherein the unit dose is selected from the group consisting of a teaspoon, a gram, a kilogram, a cup, a pint, a quart, a liter, a pound, and an ounce.

27. A method of reducing the bitter taste of a foodstuff comprising contacting the foodstuff with a bitter taste-reducing quantity of a composition comprising a bitter suppressing agent and a non-bitter sweetener.

28. A method according to claim 27 wherein the non-bitter sweetener is selected from the group consisting of sucralose, sucrose, fructose, glucose, tagatose, sugar alcohols, trehelose, and combinations thereof.

29. A method according to claim 28, wherein the sugar alcohol is selected from the group consisting of mannitol, sorbitol, lactitol, isomalt, erythritol, xylitol, maltitol, hydrogenated isomaltulose, hydrogenated starch hydrolyzates, and combinations thereof.

30. A method according to claim 28, wherein the non-bitter sweetener is sucralose.

31. A method according to claim 28, wherein the non-bitter sweetener is sucrose.

32. A method according to claim 27, wherein the contacting step is selected from the group consisting of mixing, stirring, pouring, spraying, and brushing.

33. A method according to claim 27, wherein the bitter suppressing agent is selected from the group consisting of adenosine 5′ monophosphate, thymidine 5′ monophosphate, adenosine 5′ diphosphate, adenosine 3′ monophosphate, adenosine 5′-succinate, adenosine 5′ triphosphate, adenosine 2′ monophosphate, 5′-cytidylic acid, inosinic acid, maltol, aliphatic polyols, monellin, thaumatin, ribonucleosides, ribonucleotides, deoxy analogues of ribonucleosides and ribonucleotides, D-galactose, phospholipids, cinnamic acid, derivatives, salts, and combinations thereof.

34. A method according to claim 27, wherein the bitter suppressing agent comprises a functional group that masks a receptor for bitterness.

35. A method according to claim 27, wherein the composition further comprises one or more food grade additives.

36. A method according to claim 35, wherein the food-grade additives are selected from the group consisting of a flavor, a texture enhancer, a coloring agent, a bulking agent, and combinations thereof.

37. A method of making a sweetener composition comprising combining a bitter suppressing agent with a non-bitter sweetener.

38. A method according to claim 37, wherein the composition is selected from the group consisting of sucralose, sucrose, fructose, glucose, tagatose, sugar alcohols, trehelose, and combinations thereof.

39. A method according to claim 37 further comprising combining one or more food-grade additives to the composition.

40. A method according to claim 37, wherein the food-grade additives are selected from the group consisting of a flavor, a texture enhancer, a coloring agent, a bulking agent, and combinations thereof.

41. A sweetening kit comprising, in packaged combination:
(a) a first container comprising a composition, which comprises a bitter suppressing agent and a non-bitter sweetener;
(b) a second container comprising an unsweetened beverage mix; and
(c) instructions for sweetening the unsweetened beverage mix.

42. A sweetening kit according to claim 41, wherein the non-bitter sweetener is selected from the group consisting of sucralose, sucrose, fructose, glucose, tagatose, sugar alcohols, trehelose, and combinations thereof.

43. A sweetening kit according to claim 42, wherein the sugar alcohol is selected from the group consisting of mannitol, sorbitol, lactitol, isomalt, erythritol, xylitol, maltitol, hydrogenated isomaltulose, hydrogenated starch hydrolyzates, and combinations thereof.

44. A sweetening kit according to claim 42, wherein the non-bitter sweetener is sucralose.

45. A sweetening kit according to claim 42, wherein the non-bitter sweetener is sucrose.

46. A sweetening kit according to claim 41 wherein the composition in the first container further comprises one or more food-grade additives.

47. A foodstuff comprising a composition according to claim 1.
